(19) United States
(12) Patent Application Publication
(10) Pub. No.: US 2016/0017973 A1
(43) Pub. Date: Jan. 21, 2016

(54) ASSEMBLY, COMPRISING AT LEAST AN EXPANSION MACHINE AND A GEARING

(71) Applicant: ROBERT BOSCH GMBH, Stuttgart (DE)

(72) Inventors: Thomas Steidten, Ludwigsburg (DE); Andreas Gruenberger, Spraitbach (DE)

(21) Appl. No.: 14/773,402

(22) PCT Filed: Feb. 27, 2014
(86) PCT No.: PCT/EP2014/053785

§ 371 Date: Sep. 8, 2015

(30) Foreign Application Priority Data
Mar. 6, 2013 (DE) 10 2013 203 815.1

(51) Int. Cl. F16H 47/08; F02G 5/02; F16H 13/06

(52) U.S. Cl. CPC F16H 47/08; F16H 13/06; F02G 5/02

(57) ABSTRACT

An assembly, comprising at least an expansion machine and a gearing, wherein the expansion machine, through which a fluid flows, has an output shaft, which is led out of an expansion machine housing, and wherein the output shaft is operatively connected to the gearing. According to the invention, an assembly comprising an expansion machine operatively connected to a gearing is provided, wherein the assembly is designed to be operationally reliable and durable in interaction with additional components. This is achieved in that a torsional vibration damper is arranged on the output side of the gearing, and that an output of the gearing is connected directly to an input of the torsional vibration damper. The torsional vibration damper is designed as a fluid coupling and comprises a turbine wheel and a pump wheel, wherein the pump wheel is connected directly to the output of the gearing.

### BACKGROUND OF THE INVENTION

The present invention relates to an assembly, comprising at least an expansion machine and a gearing, wherein the expansion machine, through which a fluid flows, has an output shaft which is operatively connected to the gearing.

Such an assembly comprising an expansion machine and a gearing is known from the German patent publication DE 10 2011 007 386 A1. The expansion machine is part of a system for waste heat recovery from an engine system for a ship. In this case, the ship has two internal combustion engines, the exhaust systems of which are each connected to the system for waste heat recovery. Both of these systems have in turn a common expansion machine in the form of a turbine, through which a fluid flows that has been vaporized by a heat exchanger in the respective exhaust gas line of the two internal combustion engines. The expansion machine or rather an output shaft of the expansion machine is connected via a gearing to a generator in a rotatably driven manner.

The objective underlying the invention is to provide an assembly comprising at least one expansion machine operatively connected to a gearing, wherein the assembly is designed to be operationally reliable and durable in interaction with an additional component.

### SUMMARY OF THE INVENTION

This objective is met in that a torsional vibration damper is arranged on the output side of the gearing and in that an output of the gearing is connected directly to an input of the torsional vibration damper. This design is based on the realization that, when coupling an expansion turbine to a gearing, which is connected in turn to an arbitrary additional component, for example a work machine, a decoupling of the torsional vibrations, which can originate from the expansion machine as well as from the work machine, is of particular importance in addition to a synchronization of the rotational speeds of the expansion machine and the work machine. The output shaft, which in any case is highly stressed as a result of rotor dynamics that are induced by high rotational speeds of the rotor (respectively the turbine of the expansion machine) and a residual imbalance of the rotor, has to be protected from the rotational irregularities of the work machine, which are intensified by a high-ratio gearing (1° twist on the work machine shaft corresponds, for example, to a 40° twist on the output shaft of the expansion machine at a gear ratio of 40). The torsional vibration damper, which in a general embodiment can basically be designed in an arbitrary manner, takes on this damping function. Due to the fact that the output of the gearing is connected directly to an input of the torsional vibration damper, no further coupling elements have to be provided between the gearing and the torsional vibration damper. In addition, bearing points can be saved by this design. This is advantageous with regard to a reduction in the required installation space and the manufacturing costs. Finally, the expansion machine can also be embodied in a manner which optimizes installation space as a result of this design. The expansion machine can basically be any expansion machine which is driven by a medium and which in turn is rotationally connected in the described manner to a work machine that is arbitrarily designed. In a particularly advantageous manner, the expansion machine is however part of a system for waste heat recovery from an internal combustion engine, and an output shaft of the torsion vibrational damper is connected to a crankshaft of a work machine designed as an internal combustion engine. This combination constitutes the preferred embodiment of the invention. As a result, the exhaust gas discharged through an exhaust duct is used to superheat a medium, in particular a fluid, and convert said medium into the vaporous state. The medium which has been converted into the vaporous state then flows through the expansion machine, which is particularly embodied as a turbine, and drives the same. This turbine rotating at high rotational speeds or, respectively, the output shaft thereof is reduced by the gearing and the output of the gearing is connected in a preferred manner directly to the crankshaft of the internal combustion machine using the torsional vibration damper in order to supply the internal combustion engine with the power generated in this manner. Of course, the work machine can however also be, for example, a generator or a hydraulic machine, which produces electrical energy or hydraulic energy, while staying within the scope of the invention. The work machine can also be a final drive of a vehicle, in which the internal combustion engine is installed in order to drive the same.

In a modification to the invention, the torsional vibration damper is a fluid coupling comprising at least one turbine wheel or a pump wheel, said pump wheel being connected to the output of the gearing. Such a fluid coupling constitutes an operationally reliable and durable vibration damper, which is particularly suitable even in applications of the internal combustion engine in the commercial vehicle sector which require high performance rates up to 30,000 hours or mileage rates up to 3,000,000 kilometers within the scope of the typical maintenance periods.

In a modification to the invention, the gearing is a planetary gearing designed as friction gears and comprising a ring gear, planetary gears and a sun gear, wherein the ring gear forming the output of the gearing is connected to the input of the torsional vibration damper, in particular to the fluid coupling. This embodiment constitutes the preferred design of the subject matter of the present invention.

In a modification to the invention, the pump wheel as an input of the torsional vibration damper is integrally formed with the ring gear. This embodiment has the advantage that the pump wheel and the ring gear can also be optimized with regard to the costs of materials during the corresponding manufacture thereof. In addition, it is ensured in the case of this embodiment that possible imbalances can already be compensated during manufacture. Alternatively in a further embodiment, the pump wheel is connected via a spline to the ring gear. This embodiment facilitates a simple installation of the different components and furthermore provides the advantage that the pump wheel and the ring gear can be separated from one another for servicing or repair.

In a further alternative embodiment, the pump wheel forms a composite unit with the ring gear. This composite unit can, for example, in turn be produced in a further embodiment by welding the pump wheel to the ring gear. Both of the last-mentioned options furthermore provide the advantage that different materials can be used for the pump wheel and the ring gear, which only in the case of the third embodiment have to be welded to one another or connected to one another by means of another thermal connecting procedure.

Further advantageous embodiments of the invention can be extracted from the drawings, in which an exemplary embodiment of the invention depicted in the figures is shown in detail.

### BRIEF DESCRIPTION OF THE DRAWINGS

In the drawings:

FIG. 1 shows a schematic diagram of a system for recovering waste heat from the exhaust gas stream of an internal combustion engine comprising an expansion machine which together with a torsional vibration damper and a gearing forms an assembly according to the invention;

FIG. 2 shows a cross-sectional depiction of the connection of a torsional vibration damper to the gearing as a part of the assembly.

### DETAILED DESCRIPTION

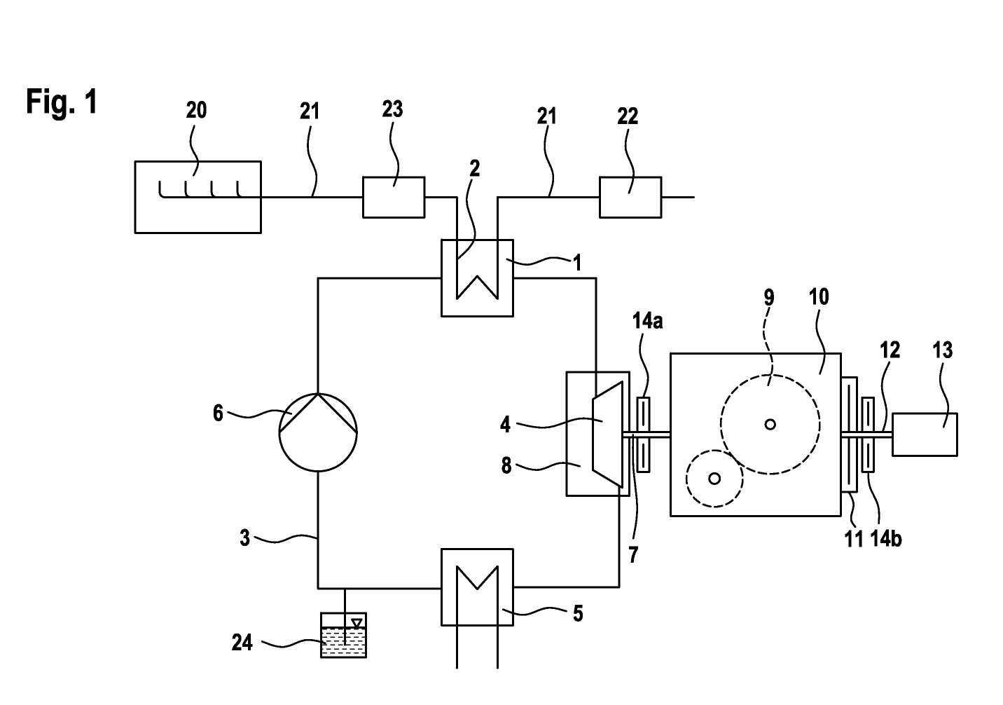

A system for waste heat recovery, which is schematically depicted in FIG. 1, has a heat exchanger 1 which is designed as a vaporizer and through which an exhaust gas stream 2 of an internal combustion engine 20 flows. During operation, the internal combustion engine is supplied with fuel and combustion air, which combust into hot exhaust gas in combustion chambers while producing work output, said exhaust gas forming the exhaust gas stream 2 during continuous operation of the internal combustion engine 20. The exhaust gas stream 2 is discharged through an exhaust gas duct 21, in which exhaust mufflers 22 as well as apparatuses for the aftertreatment of the exhaust gas in the form of, for example, a catalytic converter and/or a particle filter can be installed, ultimately into the surrounding environment. The internal combustion engine 20 is, for example, a self-igniting internal combustion engine which is operated with diesel fuel. In so doing, the diesel fuel is, for example, injected into the combustion chambers by means of a common rail injection system.

The heat exchanger 1 is in turn part of a system for the recovery of waste heat, which has a fluid circuit 3. Besides the heat exchanger 1, the fluid circuit 3 comprises an expansion machine 4, a condenser 5 and a pump 6 as well as, if applicable, a tank 24. The expansion machine 4, which is in particular a turbine, has an output shaft 7 which is disposed or, respectively, mounted in an expansion machine housing 8 and which is led out of the expansion machine housing 8 and is connected to a gearing input of a gearing 9 that is preferably a planetary gearing designed as friction gears. The gearing 9 is installed in a gearing housing 10.

The gearing 9 has a gearing output which interacts with an output shaft 12 by use of a torsional vibration damper 11, said output shaft in turn being connected to a work machine 13. The work machine 13 can be the internal combustion engine 20, wherein the output shaft 12 is then preferably directly connected to a crankshaft of the internal combustion engine 20. A seal 14b, which interacts by means of a sealing lip with the outer circumference of the output shaft 12, is provided in the region of the output of said output shaft 12 out of the torsional vibration damper 11. In the drawing, the seal 14b is arranged in an exposed manner between the gearing housing 10 or, respectively, the housing of the torsional vibration damper 11 adjoining said gearing housing 10 and the work machine 13 only for reasons of clarity and prevents the fluid situated in the gearing housing 10 or, respectively, in the torsional vibration damper 11 from escaping to the surrounding environment. A seal 14a is likewise provided on the output shaft 7 of the expansion machine 4, said seal being installed in the expansion machine housing 8 in a suitable manner. This seal 14a is likewise depicted in an exposed manner between the expansion machine 8 and the gearing 9 for reasons of clarity. Said seal 14a prevents fluid from the fluid circuit 3 from escaping out of the expansion machine housing 8 in the region of the output shaft 7.

As the case may be, the seal 14a can be integrally formed with a seal at the gearing input that is not denoted.

During operation of the system for waste heat recovery, a fluid suitable for a Rankine cycle is brought to a high pressure by the pump 6 and supplied to the heat exchanger 1, which is designed in the form of a vaporizer. The fluid vaporizes and superheats in the heat exchanger 1. The superheated steam is subsequently supplied to the expansion machine 4 and thereby expands with the provision of mechanical shaft work which is discharged via the output shaft 7. The “cold” steam is subsequently condensed and fed again to the pump 6.

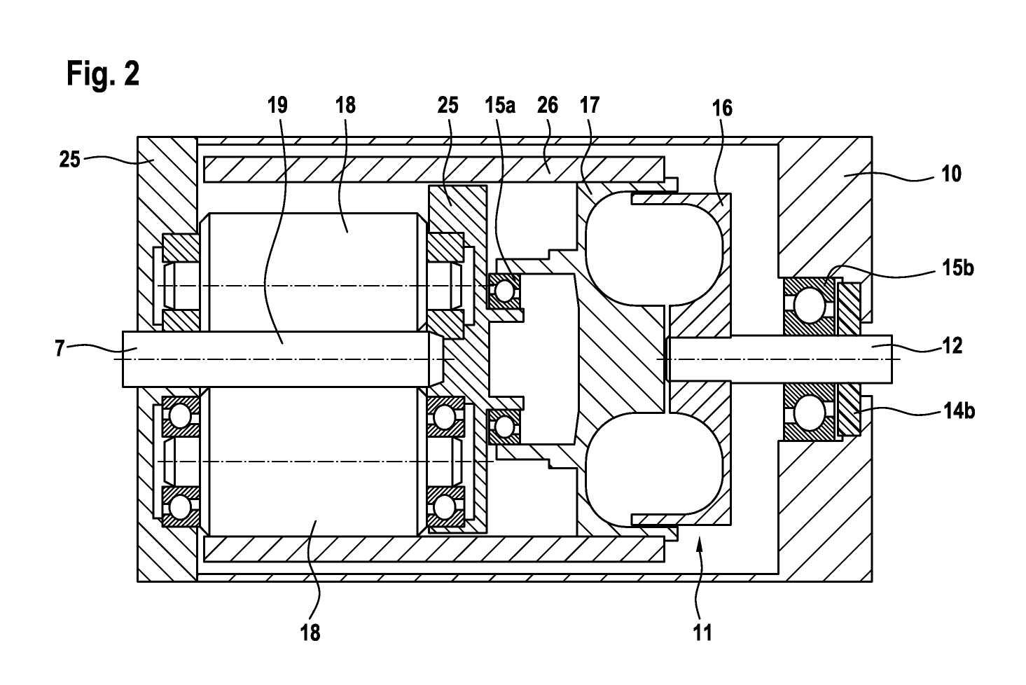

FIG. 2 shows a cross-sectional depiction of a part of an assembly, comprising the expansion machine 4, which is not shown here, the gearing 9 and the torsional vibration damper 11. The output shaft 7 of the expansion machine 4 is connected to a sun gear 19 of the gearing 9 designed as planetary gearing or else the output shaft 7 simultaneously forms the sun gear 19.

The rotational movement transmitted by the output shaft 7 to the sun gear 19 is transmitted by said sun gear 19 to a ring gear 26 via three planetary gears 18 mounted in a planetary carrier 18. The planetary gear carrier is thereby fixedly fastened to the gearing housing 10. The gearing 9 designed in this manner has, for example, a ratio of 40:1; thus enabling a high number of revolutions of the output shaft 7 of the expansion machine 4 to be translated into a slower rotational movement of the ring gear 26.

The ring gear 26 forming the output of the gearing 9 is connected directly to an input of the torsional vibration damper 11. This input is formed by a pump wheel 17 of the torsional vibration damper 11 designed as a fluid coupling. A hydraulic fluid is situated in the fluid coupling, said fluid transmitting a rotational movement of the pump wheel 17 to a turbine wheel 16. The pump wheel 17 is mounted in a bearing 15a which is supported on the planetary gear carrier 25 of the gearing 9. In addition, as previously described, the pump wheel 17 is connected directly to the ring gear 26 of the gearing 9. This connection can be produced by means of a spline or a welded connection. It is also alternatively possible to manufacture the pump wheel 17 and the ring gear 26 as one piece.

The turbine wheel 16 is connected to the output shaft 12 which is mounted by means of a bearing 15b in the gearing housing 10 or in a housing part interacting with said gearing housing 10 and is sealed by means of the seal 14b. As is depicted, the gearing housing 10 can be designed as one or multiple parts and comprise the housing for the torsional vibration damper 11.

The depicted assembly constitutes a complete, operationally reliable and durable structural unit.

1. An assembly, comprising at least an expansion machine (4) and a gearing (9), wherein the expansion machine (4), through which a fluid flows, has an output shaft (7) which is operatively connected to the gearing (9),
characterized in that a torsional vibration damper (11) is arranged on an output side of the gearing (9) and in that an output of the gearing (9) is connected directly to an input of the torsional vibration damper (11).

2. The assembly according to claim 1,
characterized in that the torsional vibration damper (11) is a fluid coupling comprising at least one turbine wheel (16) and a pump wheel (17) and in that the pump wheel (17) is connected to the output of the gearing (9).

3. The assembly according to claim 2,
characterized in that the gearing (9) is a planetary gearing including friction gears and comprising a ring gear (26), planetary gears (18) and a sun gear (19) and in that the ring gear (26) forming the output of the gearing (9) is connected to the input of the torsional vibration damper (11).

4. The assembly according to claim 3,
characterized in that the pump wheel (17) is formed integrally with the ring gear (26).

5. The assembly according to claim 3,
characterized in that the pump wheel (17) is connected via a spline to the ring gear (26).

6. The assembly according to claim 3,
characterized in that the pump wheel (17) forms a composite unit with the ring gear (26).

7. The assembly according to claim 6,
characterized in that the pump wheel (17) is welded to the ring gear (26).

8. The assembly according to claim 1,
characterized in that the expansion machine (4) is part of a system for waste heat recovery from an internal combustion engine (20).

9. The assembly according to claim 8,
characterized in that an output shaft (12) of the vibration damper (11) is connected to a crankshaft of the internal combustion engine (20).

10. The assembly according to claim 1,
characterized in that the gearing (9) is a planetary gearing including friction gears and comprising a ring gear (26), planetary gears (18) and a sun gear (19) and in that the ring gear (26) forming the output of the gearing (9) is connected to the input of the torsional vibration damper (11).
